(19) United States
(12) Patent Application Publication
(10) Pub. No.: US 2016/0194987 A1
(43) Pub. Date: Jul. 7, 2016

(54) MOUNTING ASSEMBLY FOR OIL MIST SEPARATOR

(71) Applicant: CATERPILLAR INC., PEORIA, IL (US)

(72) Inventors: RODNEY ALLEN LAWRENCE, FRANKFORT, IN (US); BRANDYN ANTHONY STACK, LAFAYETTE, IN (US); ERIC WILLIAM FERGUSON, COTTAGE GROVE, MN (US)

(73) Assignee: CATERPILLAR INC., PEORIA, IL (US)

(21) Appl. No.: 15/067,199

(22) Filed: Mar. 11, 2016

(51) Int. Cl. F01M 13/04; F02M 25/06

(52) U.S. Cl. CPC F01M 13/0416; F02M 25/06

(57) ABSTRACT

An assembly for mounting an oil mist separator to a valve cover of an engine is provided. The assembly includes a cylindrical housing having two portions and apertures to couple the cylindrical housing on the valve cover. Each portion includes a side wall, a top surface extending from a top edge of the sidewall and a bottom surface laterally spaced apart from the top surface. The bottom surface extends perpendicularly from a bottom edge of the sidewall. Each portion also includes a flange member extending from each side edge of the sidewall and fastening apertures to couple the two portion of the cylindrical housing with each other. The cylindrical housing defines a central cavity configured to receive the oil mist separator therein and to encapsulate the oil mist separator therein. Each portion further includes dampening members configured to provide mechanical support to the oil mist separator.

### TECHNICAL FIELD

The present disclosure relates to an oil mist separator of a crankcase ventilation system of an internal combustion engine. More specifically, the present disclosure relates to an assembly for mounting the oil mist separator of the crankcase ventilation system.

### BACKGROUND

Internal combustion engines typically employ crankcase ventilation (CV) systems to provide ventilation of blow-by gases generated during combustion process from a crankcase to a turbocharger and/or to atmosphere,

Generally, CV systems include an oil mist separator fabricated from thin walled and/or lightweight materials. As such, the oil mist separator may be easily susceptible to damage due to impacts, undesired heat loss to atmosphere, excessive heat flux from engine, and exhaust system.

U.S. Published Application No. 2013/0025564 describes a two-stage oil mist separator for a crankcase ventilation system. The oil mist separator includes a housing. The housing includes a lower end and an upper end. The lower end is in communication with the crankcase. The upper end is in communication with an exhaust system. The housing defines an internal flow channel extending generally upwards from the lower end toward the upper end. The oil mist separator also includes a first-stage filter element disposed toward or in the lower end. The first-stage filter element includes a first filter media of relatively coarser porosity.

Typical oil mist separators are mounted directly to a body of the crankcase ventilation system, an engine body or chassis by using brackets or clamps. Such mounting mechanisms are traditionally costly, lack durability, and have complex geometries, making the oil mist separators difficult to assemble or disassemble. Hence, there is a need for an improved mounting system for the oil mist separator.

### SUMMARY OF THE DISCLOSURE

In an aspect of the present disclosure, an assembly for mounting an oil mist separator to a valve cover integrated breather (VCIB) of an engine is provided. The assembly includes a cylindrical housing. The cylindrical housing includes a first half and a second half Each of the first half and the second half of the cylindrical housing includes a sidewall having a C-shaped cross section and defines a central axis. At least one of the first half and the second half include one or more fastening apertures on the sidewall to removably couple the cylindrical housing on the VCIB. Each half of the cylindrical housing includes a top surface extending from atop edge of the sidewall. The top surface includes a semi-circular configuration. Each half of the cylindrical housing includes a bottom surface laterally spaced apart from the top surface. The bottom surface extends perpendicularly from a bottom edge of the sidewall. The bottom surface includes an arcuate configuration. Each half of the cylindrical housing also includes a flange member extending from each side edge of the sidewall and in a direction perpendicular to the central axis. The flange member includes one or more fastening apertures to couple the two halves of the cylindrical housing with each other. The cylindrical housing defines a central cavity configured to receive the oil mist separator therein and to encapsulate the oil mist separator therein. Each half of the cylindrical housing further includes one or more dampening members provided on an inner surface of each of the two halves of the cylindrical housing. The one or more dampening members are configured to provide mechanical support to the oil mist separator.

Other features and aspects of this disclosure will be apparent from the following description and the accompanying drawings.

### BRIEF DESCRIPTION OF THE DRAWINGS

FIG. 1 is a perspective view of an exemplary engine, in accordance with an embodiment of the present disclosure;

FIG. 2 is a perspective view of a portion of an assembly mounted on a valve cover of the engine of FIG. 1, in accordance with an embodiment of the present disclosure;

FIG. 3 is a perspective view of an oil mist separator mounted within the portion of the assembly of FIG. 2, in accordance with an embodiment of the present disclosure; and

FIG. 4 is a perspective view of the assembly in an assembled state, in accordance with an embodiment of the present disclosure.

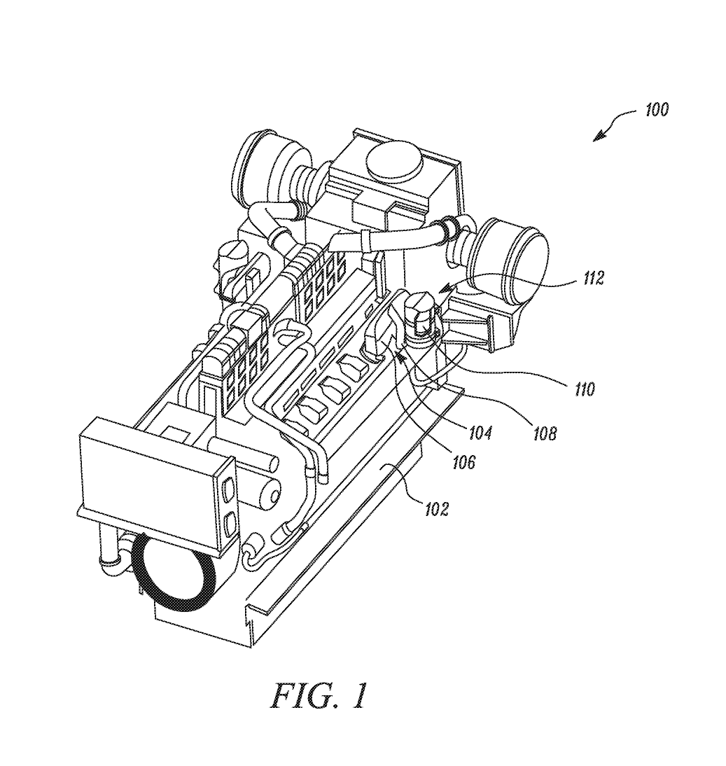

### DETAILED DESCRIPTION

Wherever possible, the same reference numbers will be used throughout the drawings to refer to the same or the like parts. Referring to FIG. 1, a perspective view of an exemplary engine 100 is illustrated. The engine 100 may be any internal combustion engine powered by any fuel known in the art such as gasoline, diesel, natural gas, and so on, or a combination thereof. The engine 100 may be used for applications including, but not limited to, power generation, transportation, construction, agriculture, forestry, aviation, marine, material handling, and waste management.

The engine 100 includes a frame 102. The frame 102 is configured to support various components (not shown) of the engine 100 such as an engine block, a crankcase, a cylinder head, a fuel system, an air system, a cooling system, peripheries, a turbocharger, an exhaust gas recirculation system, an exhaust aftertreatment system, and so on. Also, the engine 100 may be of any size including a plurality of cylinders arranged in any configuration such as inline, radial, “V”, and so on.

The engine 100 also includes a Crankcase Ventilation (CV) System 104. The CV system 104 is configured to vent blow-by gases trapped within the crankcase of the engine 100. The CV system 104 includes a Valve Cover Integrated Breather (VCIB) 106. The VCIB 106 is configured to receive the blow-by gases from the crankcase and provide partial filtration of oil present in the blow-by gases.

The CV system 104 also includes an inlet line 108 fluidly connected between the VCIB 106 and an oil mist separator 110. The inlet line 108 is configured to provide a fluid passage to the partially filtered oil from the VCIB 106 to the oil mist separator 110. The CV system 104 also includes the oil mist separator 110 configured to provide further filtration of the partially filtered oil received from the VCIB 106.

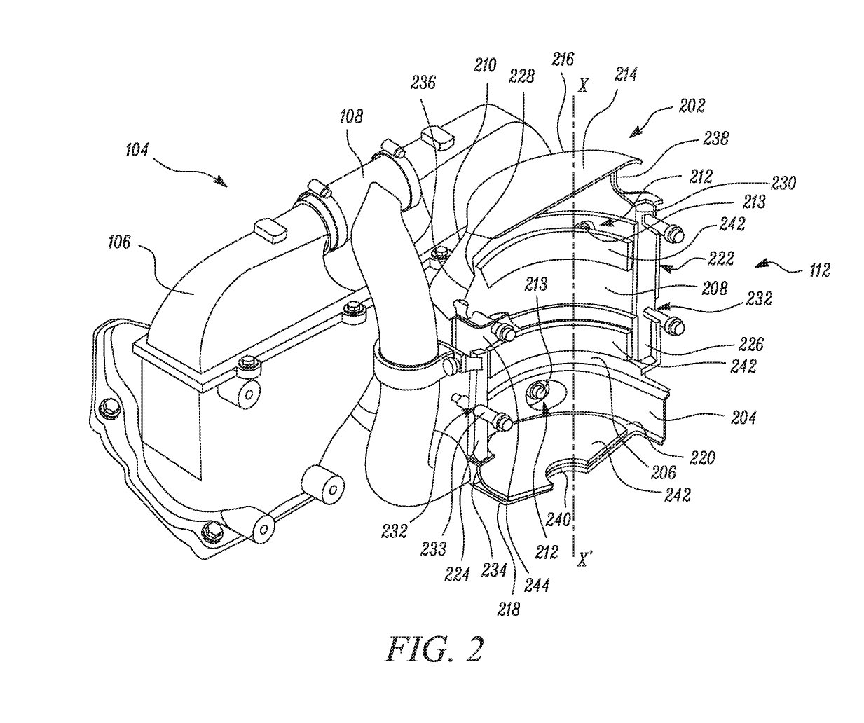

The present disclosure relates to an assembly 112 for mounting the oil mist separator 110 to the VCIB 106, Referring to FIGS. 2 to 4, the assembly 112 includes a cylindrical housing 202 having two halves, namely a first portion 204 and a second portion 404. It should be noted that the first portion 204 and the second portion 404 have a similar structure and may be utilized interchangeably, without deviating from the scope of the present disclosure.

The first portion 204 includes a first sidewall 206 having an inner surface 208 and an outer surface 210. The first sidewall 206 includes an elongated configuration defining a central axis X-X′ and a substantially C-shaped cross section. The first sidewall 206 is configured to partially cover the oil mist separator 110 along a height “H” of the oil mist separator 110. The first sidewall 206 also includes one or more apertures 212 defined through the inner surface 208 and the outer surface 210. The apertures 212 are configured to receive fastening means 213 such as bolts, screws, straps, and so on for removably mounting the first portion 204 on the VCIB 106.

The first portion 204 also includes a first top wall 214. The first top wall 214 includes a planar, semi-circular configuration. The first top wall 214 extends at an angle from a first top edge 216 of the first sidewall 206. The angle may be configured to provide a draft for easy removal of the first portion 204 from a mold during casting process. The angle may also be based on a profile of a top surface 302 of the oil mist separator 110. The first top wall 214 is configured to partially cover the top surface 302 of the oil mist separator 110.

The first portion 204 also includes a first bottom wall 218, The first bottom wall 218 is laterally spaced apart from the first top wall 214 along the central axis X-X′. More specifically, the first bottom wall 218 extends perpendicularly from a first bottom edge 220 of the first sidewall 206. The first bottom wall 218 includes a planar, arcuate configuration. The first bottom wall 218 is configured to partially cover and serve as a resting surface to a bottom surface 304 of the oil mist separator 110.

The first portion 204 further includes a flange member 222, More specifically, the flange member 222 includes a first flange member 224 and a second flange member 226. The first flange member 224 and the second flange member 226 extend from a first side edge 228 and a second side edge 230 respectively of the first sidewall 206. The first flange member 224 and the second flange member 226 extend in a direction perpendicularly away from the central axis X-X′ and opposite each other.

The first flange member 224 and the second flange member 226 also include one or more fastening apertures 232 defined thereon. The fastening apertures 232 are configured to receive mechanical fasteners 233 such as bolts, screws, straps, and so on for removably affixing the first portion 204 to the second portion 404. The first flange member 224 and the second flange member 226 is configured to provide an interference surface for interconnecting the first portion 204 with the second portion 404 and will be explained in more detail later.

Additionally, the first portion 204 includes one or more cutouts or recesses to receive one or more components of the oil mist separator 110. The first portion 204 includes a first cutout 234 provided along the first side edge 228 and adjacent to the first bottom edge 220 of the first sidewall 206. The first cutout 234 is configured to receive a first inlet 306 of the oil mist separator 110. The first portion 204 includes a second cutout 236 provided along the first side edge 228 and adjacent to the first top edge 216 of the first sidewall 206. The second cutout 236 is configured to receive a second inlet 308 of the oil mist separator 110.

The first portion 204 also includes a third cutout 238 provided along the second side edge 230 and adjacent to the first top edge 216 of the first sidewall 206. The third cutout 238 is configured to receive an outlet 310 of the oil mist separator 110. The first portion 204 further includes a fourth cutout 240 provided at a center of the first bottom wall 218. The fourth cutout 240 is configured to receive an auxiliary passage 312 such as a drain of the oil mist separator 110. The geometry of the first portion 204 described herein is exemplary. The first portion 204 may include any number of cutouts at different locations on the surface of the first portion 204 without limiting the scope of the disclosure to correspond with the geometry of the oil mist separator 110, based on the application.

Further, the first portion 204 includes one or more dampening members 242. The dampening member 242 is provided on the inner surface 208 of the first portion 204. More specifically, the dampening member 242 is provided on the first sidewall 206, the first top wall 214, and/or the first bottom wall 218. The dampening member 242 is configured to dampen vibrations between the oil mist separator 110 and the first portion 204. More specifically, the dampening member 242 may reduce vibrations to protect the oil mist separator 110 from low and high fatigue cycles. The dampening member 242 is also configured to provide mechanical support to the oil mist separator 110 and limit movement of the oil mist separator 110 within the first portion 204. The dampening member 242 may be made of any elastomeric material such as rubber, and so on. The dampening member 242 may be affixed to the inner surface 208 of the first portion 204 by any fastening means such as adhesion, bolting, and so on.

Additionally, the assembly 112 includes a bracket 244. The bracket 244 includes an L-shaped configuration. One end of the bracket 244 is removably affixed to the VCIB 106. Other end of the bracket is removably affixed to the first flange member 224. The bracket 244 is configured to provide support, in addition to the fastening means 213 provided in the apertures 212, for mounting the first portion 204 to the VCIB 106, Further, the bracket 244 is also used to support the inlet line 108, such as, hose.

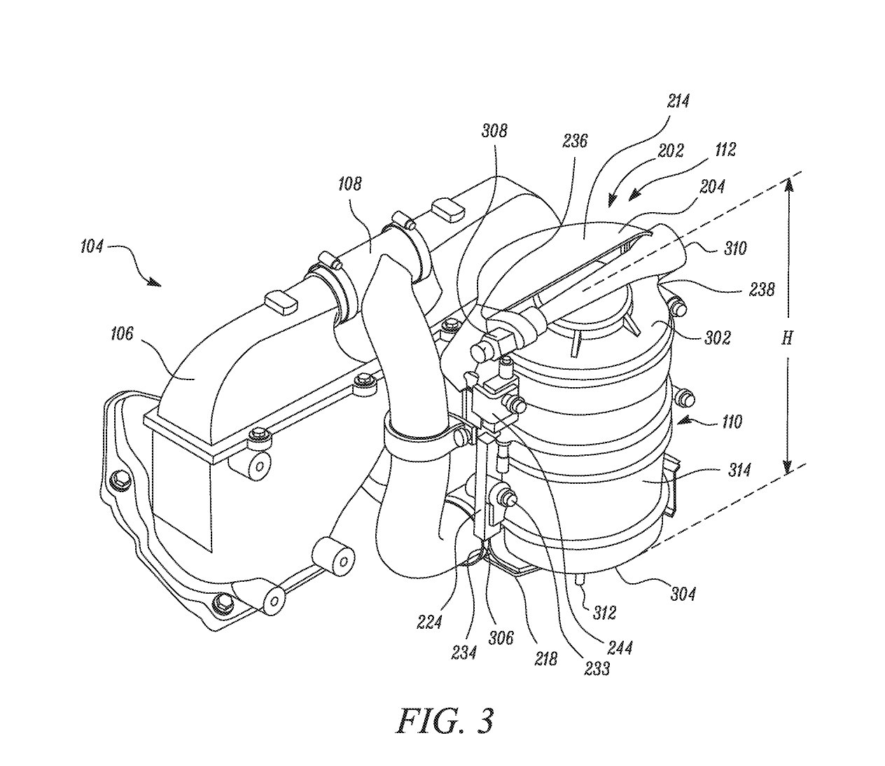

Referring to FIG. 3, during assembly, the oil mist separator 110 is partially received into the first portion 204 of the assembly 112. A side surface 314 of the oil mist separator 110 is at least partially in contact with the first sidewall 206. The top surface 302 of the oil mist separator 110 is at a pre-defined distance from the first top wall 214. The bottom surface 304 of the oil mist separator 110 at least partially rests on the first bottom wall 218.

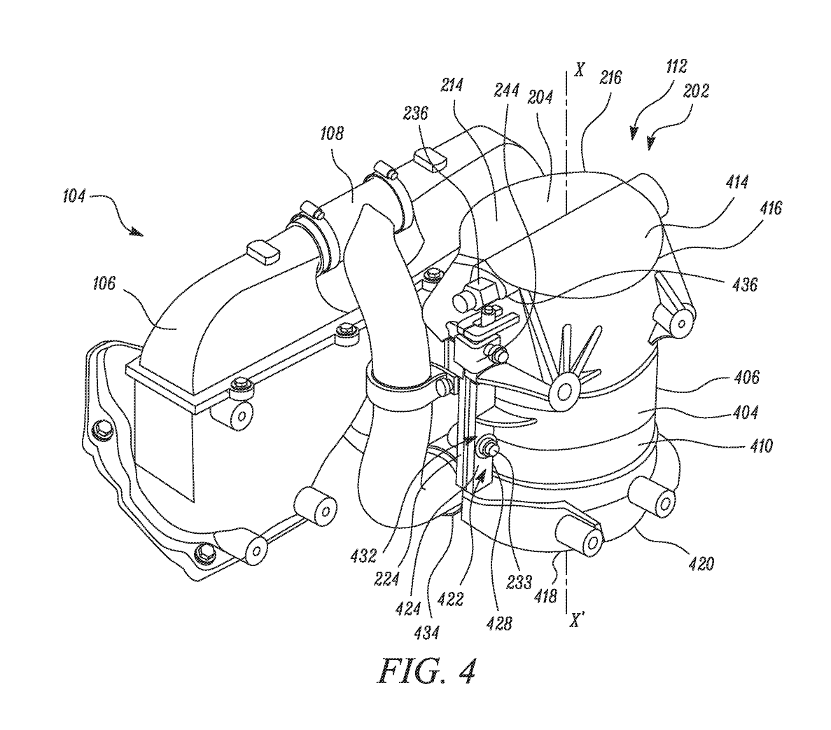

Referring to FIG. 4, the second portion 404 of the assembly 112 is configured to interconnect with the first portion 204 and cover the oil mist separator 110, such that a combination of the first portion 204 and the second portion 404 completely receives the oil mist separator 110 into a cavity defined therebetween and encapsulates the oil mist separator 110 within the assembly 112. The second portion 404 has a configuration similar to that of the first portion 204 and will now be explained in more detail.

The second portion 404 includes a second sidewall 406 having an inner surface (not shown) and an outer surface 410. The second sidewall 406 includes an elongated configuration defining the central axis X-X′ and a C-shaped cross section. The second sidewall 406 is configured to partially cover the oil mist separator 110 along the height “H” of the oil mist separator 110.

The second portion 404 also includes a second top wall 414. The second top wall 414 includes a planar, semi-circular configuration. The second top wall 414 extends at the angle from a second top edge 416 of the second sidewall 406. The second top wall 414 is configured to partially cover the top surface 302 of the oil mist separator 110.

The second portion 404 also includes a second bottom wall 418, The second bottom wall 418 is laterally spaced apart from the second top wall 414. More specifically, the second bottom wall 418 extends perpendicularly from a second bottom edge 420 of the second sidewall 406. The second bottom wall 418 includes a planar, arcuate configuration. The second bottom wall 418 is configured to partially cover and serve as a resting surface to the bottom surface 304 of the oil mist separator 110.

The second portion 404 further includes a flange member 422. More specifically, the flange member 422 includes a third flange member 424 and a fourth flange member (not shown). The third flange member 424 and the fourth flange member extend from a third side edge 428 and a fourth side edge (not shown) respectively of the second sidewall 406. The third flange member 424 and the fourth flange member extend in a direction perpendicularly away from the central axis X-X′ and opposite each other.

Each of the third flange member 424 and the fourth flange member also include one or more fastening apertures 432 defined thereon. The fastening apertures 432 are configured to receive the mechanical fasteners 233 such as bolts, screws, straps, and so on for removably affixing the second portion 404 to the first portion 204. The third flange member 424 and the fourth flange member is configured to provide the interference surface for interconnecting the second portion 404 with the first portion 204 and will be explained in more detail later.

Additionally, the second portion 404 includes one or more cutouts or recesses to receive one or more components of the oil mist separator 110. The second portion 404 includes a fifth cutout 436 provided along the third side edge 428 and adjacent to the second top edge 416 of the second sidewall 406 and corresponds to the second cutout 236. The fifth cutout 436 is configured to receive the second inlet 308 of the oil mist separator 110.

The second portion 404 also includes a sixth cutout (not shown) provided along the fourth side edge and adjacent to the second top edge 416 of the first sidewall 206 and corresponds to the third cutout 238. The sixth cutout is configured to receive the outlet 310 of the oil mist separator 110. The second portion 404 further includes a seventh cutout (not shown) provided at a center of the second bottom wall 418 and corresponds to the fourth cutout 240, The seventh cutout is configured to receive the auxiliary passage 312 such as the drain of the oil mist separator 110. It should be noted that the second portion 404 may include any number of cutouts and at any location on the surface of the second portion 404 without limiting the scope of the disclosure.

Further, the second portion 404 includes one or more dampening members (not shown). The dampening member may be provided on the inner surface of the second portion 404. More specifically, the dampening member may be provided on the second sidewall 406, the second top wall 414, and/or the second bottom wall 418. The dampening member is configured to dampen vibrations between the oil mist separator 110 and the second portion 404. More specifically, the dampening member may reduce vibrations to protect the oil mist separator 110 from low and high fatigue cycles. The dampening member is also configured to provide mechanical support to the oil mist separator 110 and limit movement of the oil mist separator 110 within the second portion 404. The dampening member may be made of any elastomeric material such as rubber, and so on. The dampening member may be affixed to the inner surface of the second portion 404 by any fastening means such as adhesion, bolting, and so on.

The oil mist separator 110 is received into the second portion 404. The side surface 314 of the oil mist separator 110 is at least partially in contact with the second sidewall 406. The top surface 302 of the oil mist separator 110 is at least partially in contact with the second top wall 414. The bottom surface 304 of the oil mist separator 110 at least partially rests on the second bottom wall 418.

More specifically, during assembly of the assembly 112, the first portion 204 mates with the second portion 404 in a manner such that the first flange member 224 and the second flange member 226 of the first portion 204 mates with the third flange member 424 and the fourth flange member of the second portion 404. Further, the first flange member 224, the second flange member 226, the third flange member 424, and the fourth flange member are interconnected in a manner to coaxially arrange the corresponding fastening apertures 232, 432. The mechanical fasteners 233 are provided through the coaxially arranged fastening apertures 232, 432 to affix the first portion 204 and the second portion 404 with one another.

In another embodiment (not shown), the assembly 112 may include the first portion 204 with the first top wall 214 omitted. As such, the first portion 204 may include the first sidewall 206 and the first bottom wall 218. Also, the assembly 112 may include the second portion 404 with the second top wall 414 omitted. As such, the second portion 404 may include the second sidewall 406 and the second bottom wall 418.

During assembly of the first portion 204 and the second portion 404, the oil mist separator 110 may be encapsulated from the bottom surface 304 and the side surface 314 while leaving the top surface 302 exposed to the atmosphere. In such an embodiment, an additional cover plate (not shown may be provided. The cover plate may have a configuration similar to the configuration of the first top wall 214 and the second top wall 414, The cover plate may be removably affixed to the first top edge 216 of the first top wall 214 and the second top edge 416 of the second top wall 414, thus, encapsulating the oil mist separator 110 within the assembly 112.

### INDUSTRIAL APPLICABILITY

The present disclosure provides the assembly 112 for mounting the oil mist separator 110 to any component of the engine 100, such as, the VCIB 106. The configurations of the first portion 204 and the second portion 404 are similar, thus, providing interchangeability of components and ease of manufacturing. Additionally, due to impact if the first portion 204 and/or the second portion 404 may be damaged, only the damaged housing component may be replaced thus reducing maintenance and replacement costs.

Further, the assembly 112 provides encapsulation to the oil mist separator 110 in a manner to reduce heat loss from the oil mist separator 110 to the atmosphere and/or reduce impact of excess heat flux to the oil mist separator 110 from surrounding heat emitting engine components. Also, the assembly 112 provides a step or a handle for an operator to climb on or hold on to for accessing other parts of the engine for maintenance purposes.

The assembly 112 also includes the dampening members 242 to reduce fatigue due to vibrations and limit movement at the radial and/or bottom locations of the oil mist separator 110 within the assembly 112 during operation of the system. The assembly 112 provides a space efficient packaging and mounting functionality to protect the oil mist separator 110. Further, the assembly 112 provides easy access to the components of a valve train of the engine 100.

The assembly 112 is suitable for multiple engine platforms and may be packaged at various locations on the engine 100. Additionally, the assembly 112 may be suitable for non-filtered open crankcase ventilation systems, filtered open crankcase ventilation systems, and/or filtered closed crankcase ventilation systems. Additionally, the assembly 112 may be adapted to be utilized for a wide range of blow-by flow levels. The approach may enable incremental blow-by flow capacity by merely adding additional crankcase ventilation modules. Accordingly, the assembly 112 may be adapted to other unit cylinder based engine platforms by simply creating one new valve cover base component. Also, the geometry of the assembly 112 provides a modular nature for easy coupling to the VCIB 106.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An assembly for mounting an oil mist separator to a valve cover integrated breather (VCIB) of an engine, the assembly comprising:
a cylindrical housing having a first portion and a second portion, wherein each of the first portion and the second portion of the cylindrical housing comprises:
a sidewall having a substantially C-shaped cross section, the sidewall defining a central axis, and wherein the sidewall includes one or more fastening apertures to removably couple at least one of the first portion and the second portion of the cylindrical housing on the VCIB;
a top surface extending from a top edge of the sidewall, the top surface having a semi-circular configuration;
a bottom surface laterally spaced apart from the top surface, the bottom surface extending perpendicularly from a bottom edge of the sidewall, the bottom surface having an arcuate configuration; and
a flange member extending from a side edge of the sidewall and in a direction perpendicular to the central axis, the flange member including one or more fastening apertures to removably couple the first portion and the second portion of the cylindrical housing with each other, wherein the first portion and the second portion defines a central cavity configured to at least partially encapsulate the oil mist separator therein; and
one or more dampening members provided on an inner surface of each of the first half and the second half of the cylindrical housing, wherein the one or more dampening members are adapted to provide mechanical support to the oil mist separator.
